(19) United States
(12) Patent Application Publication
(10) Pub. No.: US 2017/0051806 A1
(43) Pub. Date: Feb. 23, 2017

(54) Shape Recoverable And Reusable Energy Absorbing Structures, Systems And Methods For Manufacture Thereof

(71) Applicant: President and Fellows of Harvard College, Cambridge, MA (US)

(72) Inventors: Sung Hoon Kang, Lutherville Timonium, MD (US); Katia Bertoldi, Somerville, MA (US); Jordan R. Raney, Watertown, MA (US); Jennifer A. Lewis, Cambridge, MA (US); Sicong Shan, Cambridge, MA (US)

(21) Appl. No.: 15/306,038

(22) PCT Filed: Apr. 4, 2015
(86) PCT No.: PCT/US2015/027385

§ 371 Date: Oct. 21, 2016

Related U.S. Application Data
(60) Provisional application No. 61/983,782, filed on Apr. 24, 2014.

(51) Int. Cl. F16F 7/12; B33Y 80/00; B33Y 50/02; B29C 67/00; B33Y 10/00

(52) U.S. Cl. CPC F16F 7/12; B29C 67/0055; B29C 67/0088; B33Y 10/00; B33Y 50/02; B33Y 80/00; B60R 19/22

(57) ABSTRACT

An energy absorbing cell has a first structural element, a second structural element disposed parallel to and spaced apart from a first structural element, a first intermediate member, and a second intermediate member. Each intermediate member is disposed at an angle between the structural elements. A first end and a second end of each intermediate member are respectively attached to the structural elements. The intermediate members are formed from an elastic material. The angles of the intermediate members are selected such that application of a compressive force to displace the structural elements toward one another triggers a snap-through instability in both intermediate members. The energy absorbing cell is used, singly or in combination with one or more other energy absorbing cells, to form energy absorbing structures, such as vehicle bumpers or highway barriers, adapted to control the deceleration of an object impacting the energy absorbing structure.

### CROSS-REFERENCE TO RELATED APPLICATIONS

This application is a U.S. National Stage of International Application No. PCT/US2015/027385, filed Apr. 23, 2015, which claims benefit to and priority of U.S. Provisional Patent Application Ser. No. 61/983,782, filed Apr. 24, 2014, each of which are hereby incorporated by reference herein in its entirety.

### STATEMENT REGARDING FEDERALLY SPONSORED RESEARCH

This invention was made with government support under Grant No. DMR 0820484 awarded by the National Science Foundation (NSF). The government has certain rights in the invention.

### BACKGROUND

1. Field of the Invention

The present concepts broadly relate to energy absorbing structures configured to decelerate an object that impacts the structure. More particularly, present concepts deal with energy absorbing elements, such as bumpers in automobiles and highway fence used in roadside facilities.

2. Discussion of Related Art

Car crashes are among the most common and most serious accidents in daily life. In US alone, there were 0.2 billion registered vehicles in 2000. In 1999, there were 6.3 million police-reported traffic crashes in US, with 42,000 deaths and 4.2 million dollars in property damage. An important objective in the design of modern automobile is the protection of traffic occupants, both inside and outside the vehicle.

Crash injuries may be caused by high acceleration loads experienced by the occupants, or the loss of structural integrity. The force applied by an impact is proportional to acceleration, with larger forces/accelerations generally leading to more serious damage to people and structures. Controlled deceleration of the vehicle during impact reduces inertial loads on the occupants and assists in maintaining structural integrity of the vehicle. By way of example, car bumpers are provided, as one safety feature, to provide energy absorption to control vehicle deceleration during a crash impact.

Previous and existing generations of crash energy absorption systems used in car bumpers and roadside fences relied heavily on deformable metal components to absorb kinetic energy during a crash. However, the increasing use of cellular or porous structures as cushioning material has resulted in newer crash energy absorption systems that rely on components formed of these materials.

Energy absorbing systems are frequently made with metals (e.g., steel, aluminum, alloys, etc.) or elastic materials (e.g., hard rubber, etc.). The metals undergo a plastic deformation with a near-constant reaction force to prevent the vehicle from suffering peak load acceleration. This irreversible energy conversion, converting the input kinetic energy into inelastic energy by plastic deformation or other dissipation processes, has been regarded as essential for energy absorbing structures because the release of elastic energy after maximum elastic deformation can cause subsequent damage to the person and structure to be protected. In contrast, energy absorbing structures made from hard-rubber are usually recoverable and cost-effective.

Energy absorbing systems that use these conventional materials present a design challenge because these materials are either non-recoverable (i.e., they plastically deform) or exhibit peak acceleration prior to failure.

Energy absorbing materials are used widely in engineering applications, including personnel protection, crash mitigation in automobiles and aircraft, and protective packaging of delicate components. These materials often dissipate energy via irreversible microstructural changes, such as fragmentation in ceramics, plastic deformation in metallic foams and thin walled tubes, and microfragmentation in composites. Viscous processes, either due to fluid flow or due to intrinsic properties of materials, are also exploited to absorb energy, but system response is affected by the rate of the applied load and the temperature of the surrounding environment. Additional dissipative phenomena have been proposed, such as the zipping and unzipping of van der Waals interactions and sliding interactions in carbon nanotube-based materials. However, there are often challenges in these systems with consistency of properties under repeated loading, as well as inherent scaling and environmental challenges associated with the use of nanomaterials.

### SUMMARY OF THE INVENTION

According to one aspect of the present invention, an energy absorbing cell is provided that includes a first structural element, a second structural element disposed at least substantially parallel to the first structural element and spaced apart from the first structural element by a gap, a first intermediate member and a second intermediate member. Each of the first intermediate member and the second intermediate member are disposed at an angle, which may be equal, between the first structural element and the second structural element. A first end and a second end of each of the first intermediate member and the second intermediate member are respectively attached to the first structural element and the second structural element. The first intermediate member and the second intermediate member are formed from an elastic material. The angle(s) of the first intermediate member and the second intermediate member are selected so that application of a compressive force to displace the first structural element and the second structural element toward one another triggers a snap-through instability in both the first intermediate member and the second intermediate member.

According to another aspect of the invention, an energy absorbing structure includes a plurality of energy absorbing cells, including at least a first energy absorbing cell and a second energy absorbing cell. The first energy absorbing cell comprises a first structural element, a second structural element disposed at least substantially parallel to the first structural element and spaced apart from the first structural element by a gap, a first intermediate member disposed at a first angle between the first structural element and the second structural element and being attached at a first end to a first portion of the first structural element and being attached at a second end to a first portion of the second structural element, and a second intermediate member disposed at a second angle, between the first structural element and the second structural element and being attached at a first end to a second portion of the first structural element and being attached at a second end to a second portion of the second structural element, at least the first intermediate member and the second intermediate member being formed from an elastic material, and the first angle and the second angle being selected so that application of a compressive force to displace the first structural element and the second structural element toward one another triggers a snap-through instability in both the first intermediate member and the second intermediate member. The second energy absorbing cell comprises a first structural element, a second structural element disposed at least substantially parallel to the first structural element and spaced apart from the first structural element by a gap, a first intermediate member disposed at a first angle between the first structural element and the second structural element and being attached at a first end to a first portion of the first structural element and being attached at a second end to a first portion of the second structural element, and a second intermediate member disposed at a second angle, between the first structural element and the second structural element and being attached at a first end to a second portion of the first structural element and being attached at a second end to a second portion of the second structural element, at least the first intermediate member and the second intermediate member being formed from an elastic material, and the first angle and the second angle being selected so that application of a compressive force to displace the first structural element and the second structural element toward one another triggers a snap-through instability in both the first intermediate member and the second intermediate member. The plurality of energy absorbing cells may comprise any number of energy absorbing cells, in any arrangement. Moreover, one or more energy absorbing cells may differ from one or more of the other plurality of energy absorbing cells with respect to any one or more of the first structural element, second structural element, gap between the first structural element and second structural element, first intermediate member, first angle, first intermediate member attachment points, second intermediate member, second angle, second intermediate member attachment points, elastic material (e.g., a first energy absorbing cell is formed from a first elastic material and a second energy absorbing cell is formed from a second elastic material). Stated differently, one or more characteristics of one or more energy absorbing cells may be tailored to differ from corresponding characteristics of one or more energy other absorbing cells to yield different performance profiles in different portions of the energy absorbing structure.

According to another aspect of the invention, a method of forming an energy absorbing cell includes the acts of programming an additive manufacturing system to output, from one or more nozzles, one or more viscoelastic materials to print an energy absorbing cell, and cross-linking the printed energy absorbing cell by applying energy (e.g., heat, UV light, etc.) to the printed energy absorbing cell at a predetermined rate/level (e.g., a predetermined heat, etc.) and for a predetermined time period. The printed energy absorbing cell comprises a first structural element, a second structural element disposed at least substantially parallel to the first structural element and spaced apart from the first structural element by a gap, a first intermediate member disposed at a first angle between the first structural element and the second structural element and being attached at a first end to a first portion of the first structural element and being attached at a second end to a first portion of the second structural element, and a second intermediate member disposed at a second angle between the first structural element and the second structural element and being attached at a first end to a second portion of the first structural element and being attached at a second end to a second portion of the second structural element, the first angle and the second angle being selected so that application of a compressive force to the formed energy absorbing cell to displace the first structural element and the second structural element toward one another triggers a snap-through instability in both the first intermediate member and the second intermediate member.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1(a) shows a sequential collapsing of a multistable energy absorption structure, according to at least some aspects of the present concepts.

FIG. 1(b) shows a sequential collapsing of a modeled multistable structure, according to at least some aspects of the present concepts.

FIG. 2(a) is force-displacement schematic drawing of the stress-strain curve for one tilted intermediate member of an energy absorbing structure according to at least some aspects of the present concepts.

FIG. 2(b) is force-displacement schematic drawing of the stress-strain curve for an energy absorbing structure according to at least some aspects of the present concepts comprising a plurality of tilted intermediate members under compressive forces.

FIG. 3(a) shows a representation of energy absorption in an elastic beam buckling under uniaxial compression and recovery of its initial shape when unloaded, according to at least some aspects of the present concepts.

FIG. 3(b) shows a representation of energy absorption in a constrained tilted elastic beam snapping between two stable configurations when one of its ends is moved vertically, with the structure maintaining its deformed shape when unloaded, according to at least some aspects of the present concepts.

FIG. 4(a) shows a variety of unit cells in accord with at least some aspects of the present concepts, each with a unique combination of geometrical parameters, manufactured using direct-write 3D printing in accord with at least some aspects of the present concepts.

FIG. 4(b) is a schematic showing the 2D model used in FE simulations (left) and the corresponding beam in the fabricated unit cell (right), shown in FIG. 4(a), according to at least some aspects of the present concepts.

FIG. 4(c) shows normalized numerical and experimental force-displacement curves for three beams in accord with at least some aspects of the present concepts, the beams being characterized by (θ,t/L)=(25°,0.15), (40°,0.12), (60°,0.14) according to at least some aspects of the present concepts.

FIG. 4(d) shows the effect of θ and t/L on the energy absorbed by the elastic beam (Eᵢₙ) according to at least some aspects of the present concepts.

FIG. 4(e) shows the effect of θ and t/L on the energy cost for the beam to snap back to its undeformed configuration (Eₒᵤₜ) according to at least some aspects of the present concepts.

FIG. 4(f) shows and example of a unit cell according to at least some aspects of the present concepts.

FIG. 5(a) shows a mechanical response of an elastic multistable structure in accord with at least some aspects of the present concepts, with a first image of the multistable structure being loaded vertically showing progressive deformation upon loading and retention of the deformed shape after unloading.

FIG. 5(b) shows a second sequential image of the multistable structure of FIG. 5(a).

FIG. 5(c) shows a third sequential image of the multistable structure of FIG. 5(a).

FIG. 5(d) shows a fourth sequential image of the multistable structure of FIG. 5(a).

FIG. 5(e) shows a fifth sequential image of the multistable structure of FIG. 5(a).

FIG. 5(f) shows a sixth sequential image of the multistable structure of FIG. 5(a).

FIG. 5(g) shows stress-strain curves for the multistable structure of FIGS. 5(a)-5(f) at multiple strain rates in accord with at least some aspects of the present concepts, with the measurements being repeated five times for each strain rate, showing excellent repeatability for the sample and as between multiple samples with the same geometric properties.

FIG. 5(h) shows a comparison between experiments and simulations according to at least some aspects of the present concepts.

FIG. 6(a) shows an example of undeformed, initial states of structures according to at least some aspects of the present concepts manufactured at different length scales.

FIG. 6(b) shows an example of deformed states of the structures of FIG. 6(a).

FIG. 6(c) shows sequential images of a bistable unit cell according to at least some aspects of the present concepts, wherein the unit cell is loaded vertically and wherein the unit cell is not attached to the upper plate in the upper “unattached” series of images and is attached to the upper plate in the “glued” series of images.

FIG. 7 shows an apparatus for drop testing a multistable structure in accord with at least some aspects of the present concepts against a control structure and before and after images of a drop test of such multistable and control structures, with raw eggs attached to their top, from 12.5 cm.

FIG. 8 shows data from the drop testing using the apparatus of FIG. 7 to test the responses of the multistable structure in accord with at least some aspects of the present concepts against the control structure, with subpart A showing an acceleration-time curve for a multistable and the control structures, subpart B showing an enlargement of a portion of the acceleration-time curves of subpart A, subpart C showing peak acceleration amplitude as a function of the drop height h, and subpart D showing acceleration-time curves for the multistable sample obtained from drop heights of 5 cm, 7.5 cm and 10 cm.

FIG. 9 shows, according to at least some aspects of the present concepts, a viscosity of the PDMS ink for shear rates relevant to the extrusion used during 3D printing (left) and the shear elastic and loss moduli of the ink as a function of shear stress (right).

FIG. 10 shows nominal stress versus nominal strain in uniaxial tension for a cured PDMS-based ink, used in test structures according to at least some aspects of the present concepts, providing a comparison between experimental data and model predictions.

FIG. 11 shows schematic views of exemplary embodiments of energy-trapping meta-materials in accord with at least some aspects of the present concepts comprising a combination of bistable intermediate members and rigid support structures.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

The present concepts generally relate to energy absorbing structures and methods for forming such energy absorbing structures and utilizing such energy absorbing structures, wherein the energy absorbing structure is adapted to absorb energy between two interacting bodies (e.g., to decelerate an object impacting the energy absorbing structure) in a predictable and repeatable manner.

In at least one presently preferred aspect, the energy-absorbing structure is a reusable structure constructed from common elastic materials, whose response is completely reversible and unaffected by the scale of the system, the rate of the applied load, and the loading history. Unlike traditional dissipative processes, which are microscale or nanoscale in origin or in entirety, here the response of the system is dictated by structural geometry. The energy absorption is governed by a prescribed change in state of simple, bistable, tilted elastic beams.

In at least one aspect of the present concepts, the energy-absorbing structures are formed using an additive manufacturing technique (AM, also known as 3D printing), direct ink writing with numerical Finite Element simulations or numerical analysis, to efficiently and reproducibly produce customizable, reusable energy-absorbing structures from common, inexpensive elastic materials. The response of the formed energy-absorbing structures is solely dependent on its structural geometry and is unaffected by its scale, the rate of the applied load, and the loading history, thus providing a highly customizable energy-absorbing materials and structures that may be advantageously utilized in application areas as diverse as, but not limited to, transportation, consumer products, and personnel protection. The disclosed concepts reveal scalable energy-absorbing systems that not only dissipate mechanical energy, but also provide mechanical responses independent of both the history and the rate of loading, enabling reusability and a predictable response in uncertain loading conditions. In contrast, conventional solutions to energy absorption have focused on the development of materials with increased available mechanical energy dissipation for a given mass, which rely upon exotic and expensive materials, non-scalable fabrication routes, or history-dependent mechanical responses.

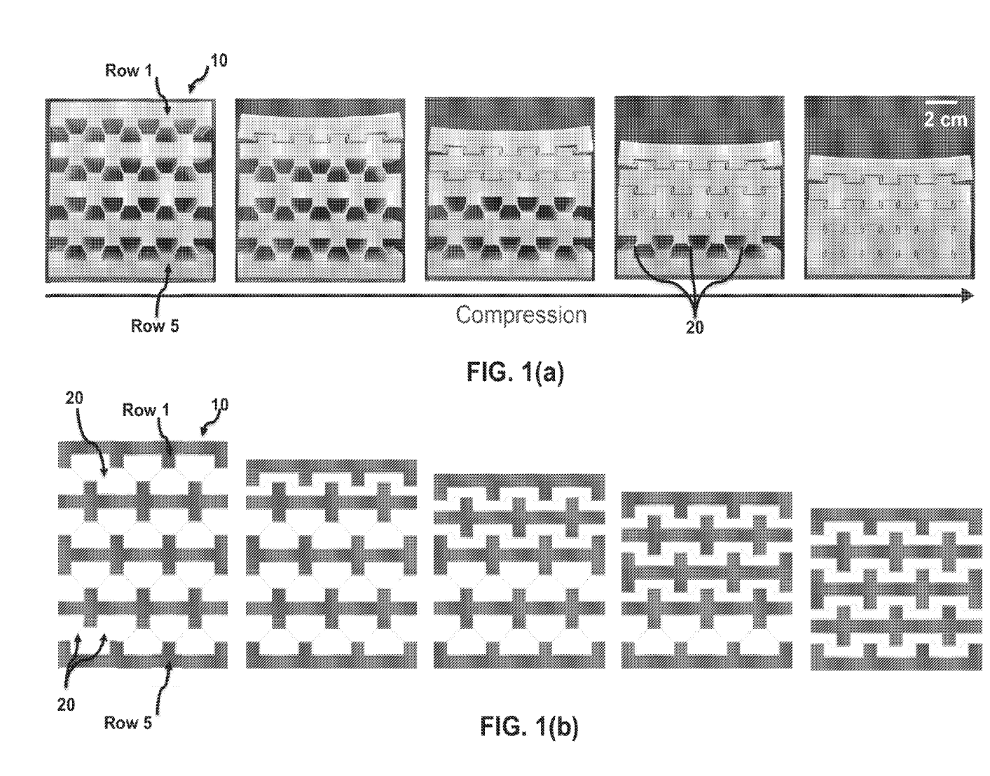

FIG. 1 shows aspects of one example of a multistable energy absorption structure comprising repetitive rows of structure, in serial, in accord with the present concepts wherein. Each row is connected to adjacent rows by a number of intermediate structures (e.g., beams, arches, etc.) configured to snap through to an inverted, stable configuration. As a force of a level sufficient to cause deformation of at least one row of the intermediate structures is applied, the at least one row of intermediate structures snaps-through to its inverted configuration, with the space between the rows adjacent to the at least one row of intermediate structures decreasing in correspondence with the realized inverted configuration and with energy being stored in the deformed intermediate structures. Each row of intermediate structures can perform individually or collectively during impact/deformation depending on the energy of the impact and any customization of the intermediate structures. By way of example, in one aspect of the present concepts, intermediate structures disposed between different rows of structural elements may be configured to possess similar energy absorption and/or deformation characteristics and, in another aspect of the present concepts, intermediate structures disposed between different rows of structural elements may be configured to possess different energy absorption and/or deformation characteristics.

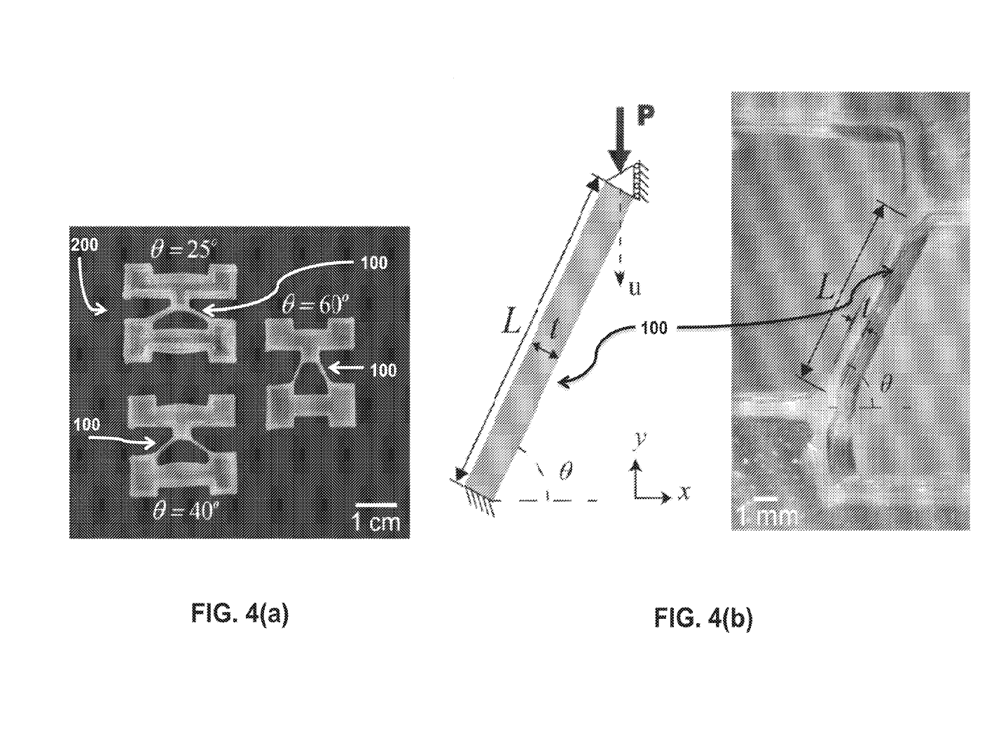

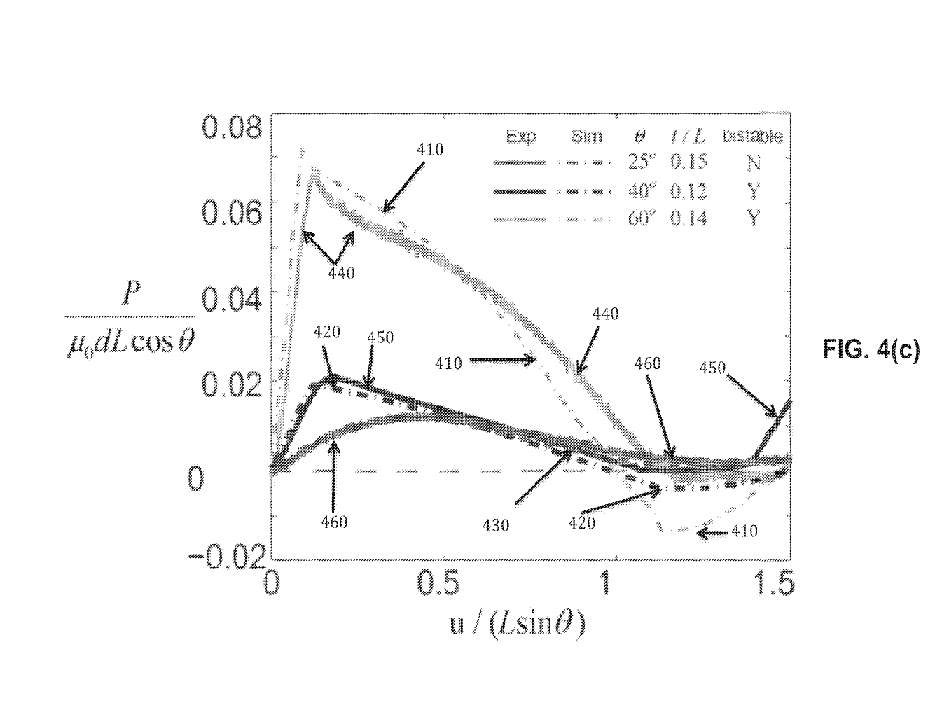

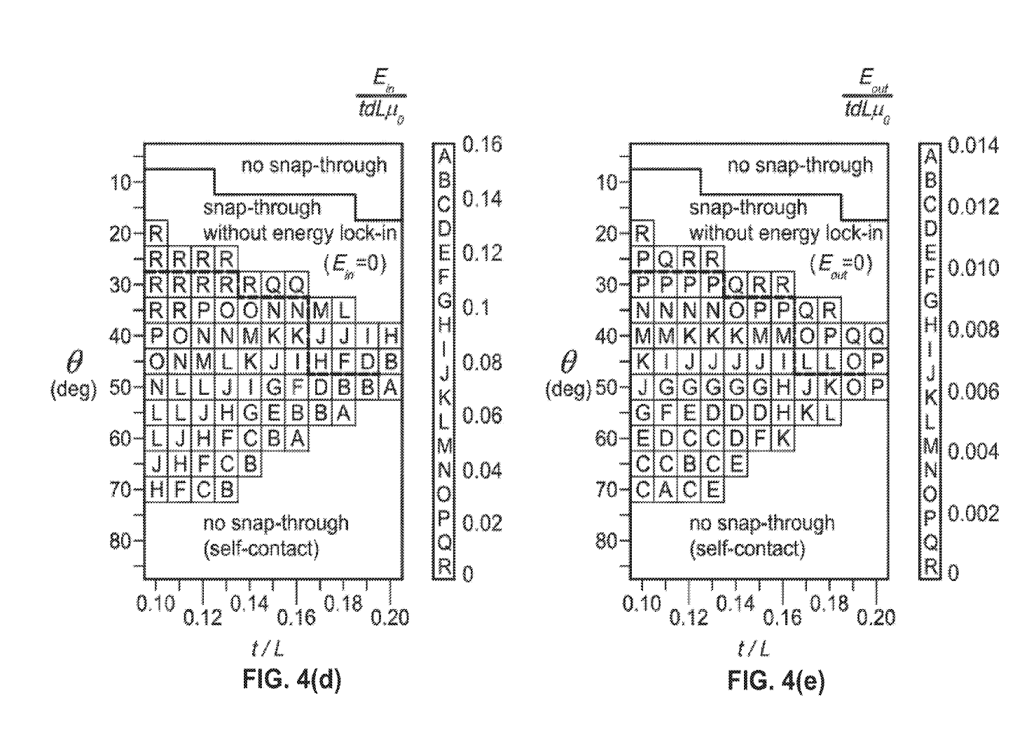

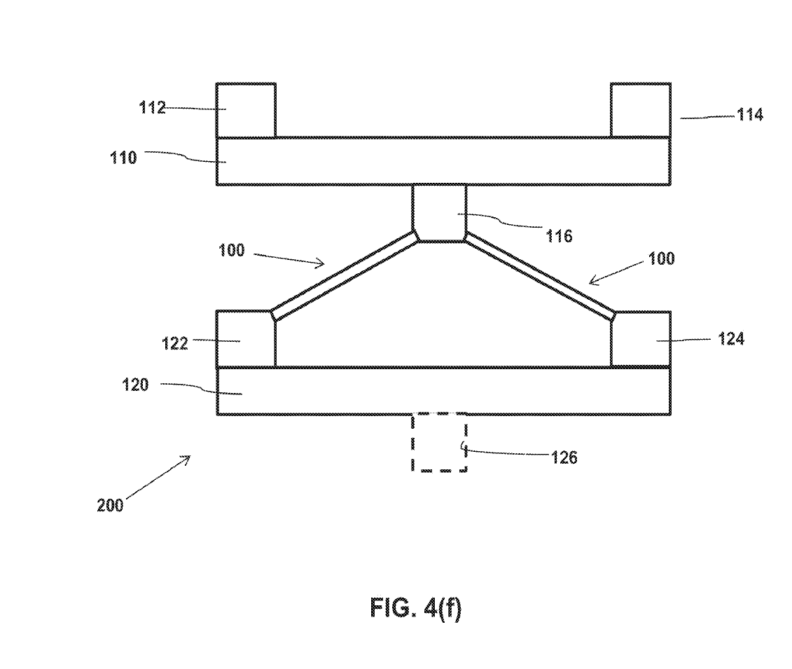

It is to be emphasized that the structure depicted in FIG. 1 is exemplary in nature and is not limiting on the concepts expressed herein. In general, any number of similar or dissimilar (e.g., different similar energy absorption and/or deformation characteristics) unit cells (see, e.g., FIG. 4(a)) of the energy absorption structure may be arranged in any order (e.g., one level, multiple levels, etc.) or geometric shape (e.g., square, rectangular, polygonal, etc.) to provide desired energy absorption and/or deformation characteristics that may be tailored to specific anticipated loadings and applications. Advantageously, opposing surfaces of adjacent rows of structural elements are configured to matingly engage one another, via correspondingly dimensioned and situated protrusions and recesses formed in the structural elements, when the intermediate structures therebetween are forced into the inverted state.

FIG. 1(a) shows, in the leftmost image, an initial (undeformed) state of a multistable energy absorption structure 10 in accord with at least some aspects of the present concepts. For purposes of discussion, the uppermost row of the structural elements will be denoted as row 1 and the lowermost row of the structural elements will be denoted as row 5. As force is applied to compress the multistable energy absorption structure 10, the multistable energy absorption structure progressively transitions through a variety of states during the controlled deformation. In state 1, the second image from the left, the two bottommost rows of structural elements (rows 4 and 5) collapse so as to be in a substantially contiguous relationship as the intermediate structures therebetween deform to the inverted state, thereby absorbing some of the incident applied forces. In state 2, the middle image, the middle row of structural elements (row 3) collapses so as to cause the lower surfaces of row 3 to be in a substantially contiguous relationship with upper surfaces of row 4 as the intermediate structures therebetween deform to the inverted state, thereby absorbing some of the incident applied forces. Likewise, in stage 3, the second image from the right, row 2 of structural elements collapses so as to place lower surfaces thereof in a substantially contiguous relationship with upper surfaces of row 3 as the intermediate structures therebetween deform to the inverted state, thereby absorbing some of the incident applied forces. Lastly, in stage 4, the rightmost image, row 1 collapses so as to place lower surfaces thereof in a substantially contiguous relationship with upper surfaces of row 2 as the intermediate structures therebetween deform to the inverted state, thereby absorbing some of the incident applied forces.

FIG. 1(b) shows a finite element simulation of the deformation process of the multistable energy absorption structure 10 of FIG. 1(a). The structure 10 undergoes a sequential collapsing, in a row-by-row manner, until it reaches a fully collapsed state, shown at the right of FIGS. 1(a)-1(b).

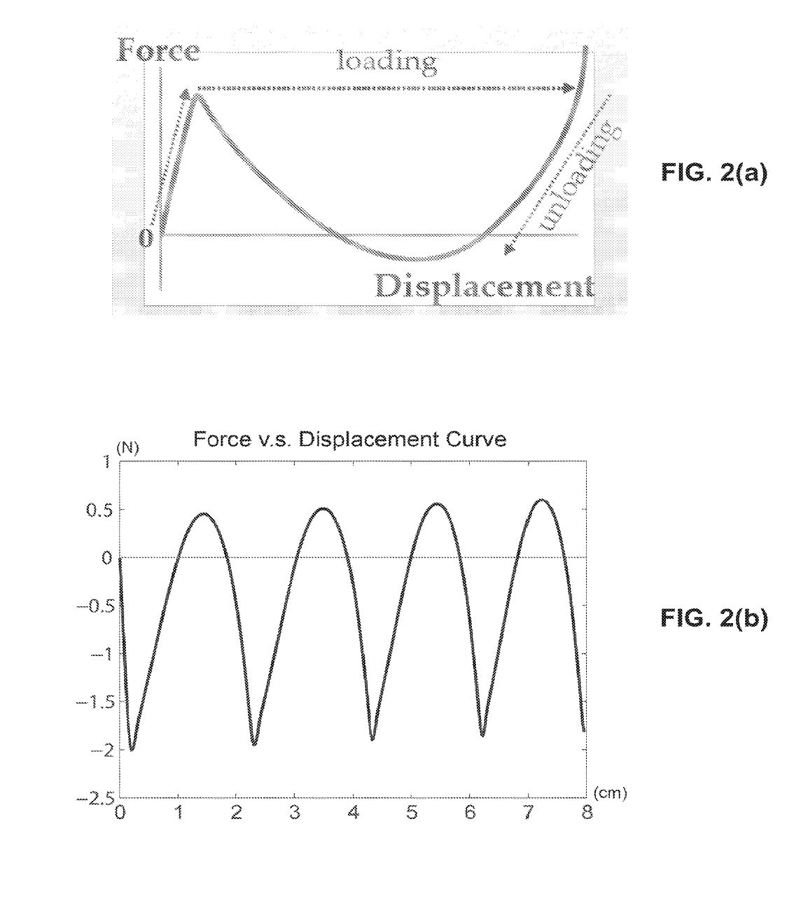

To explain the energy absorption mechanism, FIG. 2(a) shows the force-displacement of a single unit cell of an energy absorption structure 10, comprising a first base structure having a first protrusion having a first and a second intermediate structure extending therefrom to attached to a corresponding first and second protrusion on an adjacent second base structure, wherein the first and second protrusions of the second base structure are disposed laterally to the first protrusion of the first base structure so as to permit at least substantially mating engagement of the first base structure and second base structure upon absorption of energy by the first and second intermediate structures. As is shown in FIG. 2(A), when this energy absorbing structure unit cell 200 (see, e.g., FIG. 4(a), FIG. 4(f)) is loaded, work is done by the forces applied to it. The reaction force increases almost linearly when the intermediate structures are first deformed. Then the reaction force reaches a maximum level begins to decline, while maintaining the direction. At a certain displacement, the reaction forces are zero and the direction of the reaction force reverses to drive the structure to another inverted stable configuration. Energy/work is stored in the “snap-through” process. The work stored per intermediate structure is simply the area under the hump of the force-displacement curve. During the unloading process, the structure, whether an individual unit cell 200 or a larger energy absorption structure 10 comprising a plurality of individual unit cells, remains in the collapsed configuration unless the structure is put into enough tension to overcome the inversed hump. When loaded in tension, the structure 10, 200 then snapped to its initial configuration, while releasing the energy stored during the compression. Thus, in at least some aspects of the present concepts, the energy absorption structure 10, 200 is reversible and is able to recover its original configuration.

Turning to FIGS. 1(a)-1(b) and FIG. 2(b), very little energy is absorbed in the short linear-elastic regime at the beginning of a collapse of each row energy absorption structure 10. A large initial region of the force displacement curve with limited peak reaction force arising from cell collapse by snap-through allows large energy to be absorbed at a small load. The maximum reaction force for this structure is determined by the elastic deformation and “snapping” of the cells 200 (i.e., deformation characteristics of the intermediate members). Although this is a form of elastic deformation, much of the external work stored will not be released again once the structure (e.g., energy absorption structure 10, unit cell 200, etc.) is unloaded. This indicates that the compression of this energy absorption structure, arising from the inverted configuration of the snapping intermediate elements, is more dissipative than conventional elastic materials. The portion of energy which is enveloped by the stress-strain curve is locked-in temporarily at its compressed configuration. However, if a tensile force is applied to the structure, it will again recover its original shape and release the energy stored during previous compression. The tensile force (or energy) required to be applied to cause the energy-absorbing structure 10 to recover its initial shape is generally much smaller than the force (energy) required to trigger the snap-through.

In accord with the above, the unit cells 200 provide a reusable, energy-absorbing structure suitable for integration into larger energy absorption structures 10 comprising a plurality of such unit cells (which may be uniform or dissimilar in structure) configured to provide a response that is completely reversible and unaffected by the scale of the system, the rate of the applied load, and the loading history. Desirably, the unit cells 200 and energy absorption structure 10 are formed from common elastic materials. It is to be noted that, as used herein, the term elastic is intended to mean not only materials such as elastomers, but also thin metals or other materials (e.g., ceramics, composite materials, etc.) that can show elastic behaviors up to a large strain. By way of example, the thickness of these metals or other materials may be between about 100-500 nm and the large strain may be represented by strains up to 50%. In general, the unit cells 200 and energy absorption structure formed from one or more cells comprise one or more elastic material(s) able to resume the initial shape spontaneously after deformation or distortion. Unlike conventional dissipative processes, previously noted, which are microscale or nanoscale in origin or in entirety, the dissipation in the system described here depends solely on the (reversible) change in state of prescribed structural geometries.

Although the unit cells 200 and energy absorption structure 10 may be manufactured using additive manufacturing techniques, such as but not limited to direct ink writing with numerical Finite Element simulations, the structures may be manufactured by other conventional molding or forming processes. The particular configuration of the energy absorption structure 10 and performance or response characteristics thereof are entirely customizable.

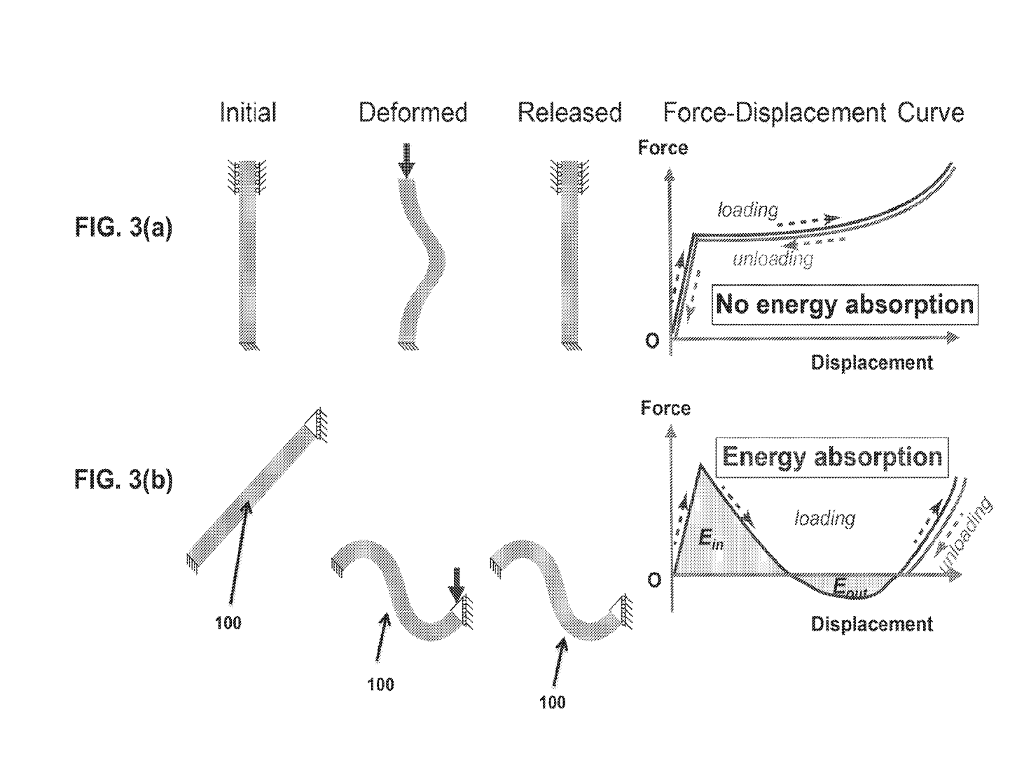

The present concepts exploit the “snap-through” instability that can be observed in certain constrained beams to design highly modular elastic energy absorption structures 10 that absorb energy consistently over a wide range of strain rates and yet deform reversibly, allowing repeated loading cycles with indistinguishable dissipative properties. The minimal building block of the energy absorption structure 10 consists of a unit cell 200 comprising two tilted elastic beams, or intermediate members 100, disposed between structures (e.g., 116, 122, 124) on adjacent rows (e.g., 110, 120) of the unit cell, as is shown by way of example in FIG. 4(f). In contrast to a vertical, elastic beam that buckles under axial compression, but fully recovers its initial shape when unloaded (see FIG. 3(a)), a tilted beam or intermediate member 100 snaps between two different stable configurations and retains its deformed shape after unloading (FIG. 3(b)). Such a bistable tilted intermediate member 100, also denoted herein without limitation generally as a “beam” for simplicity, has been determined to be capable of locking in most of the energy inserted into the system during loading (quantified by the shaded area under the corresponding force-displacement curve), indicating that it can be suitably used as an energy absorbing element.

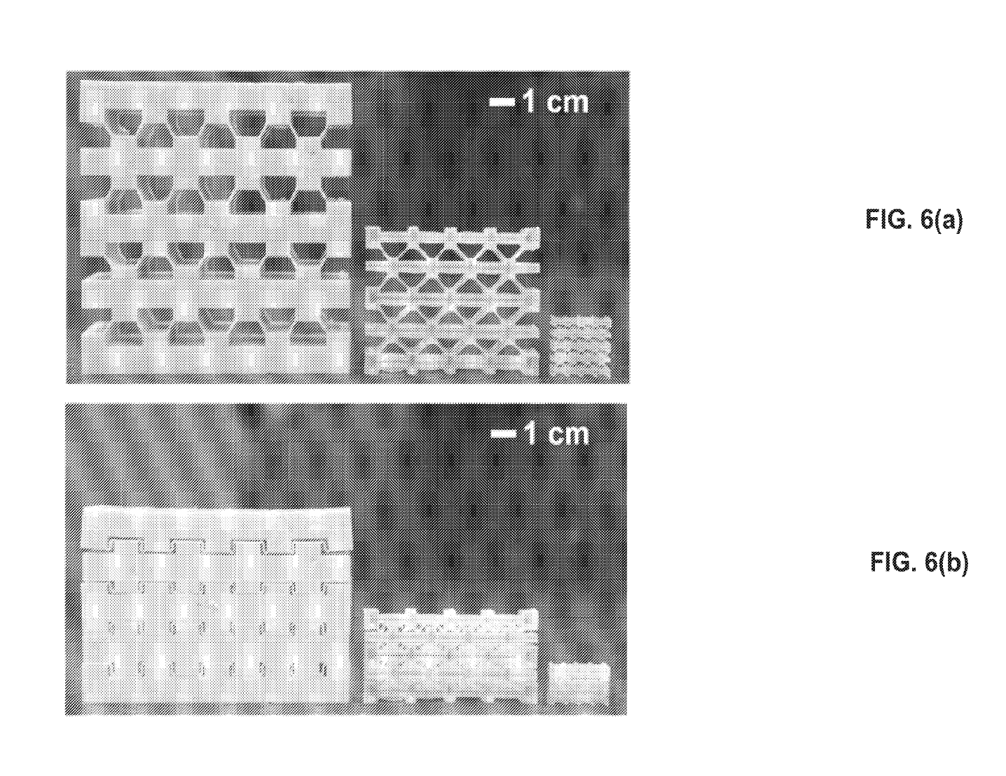

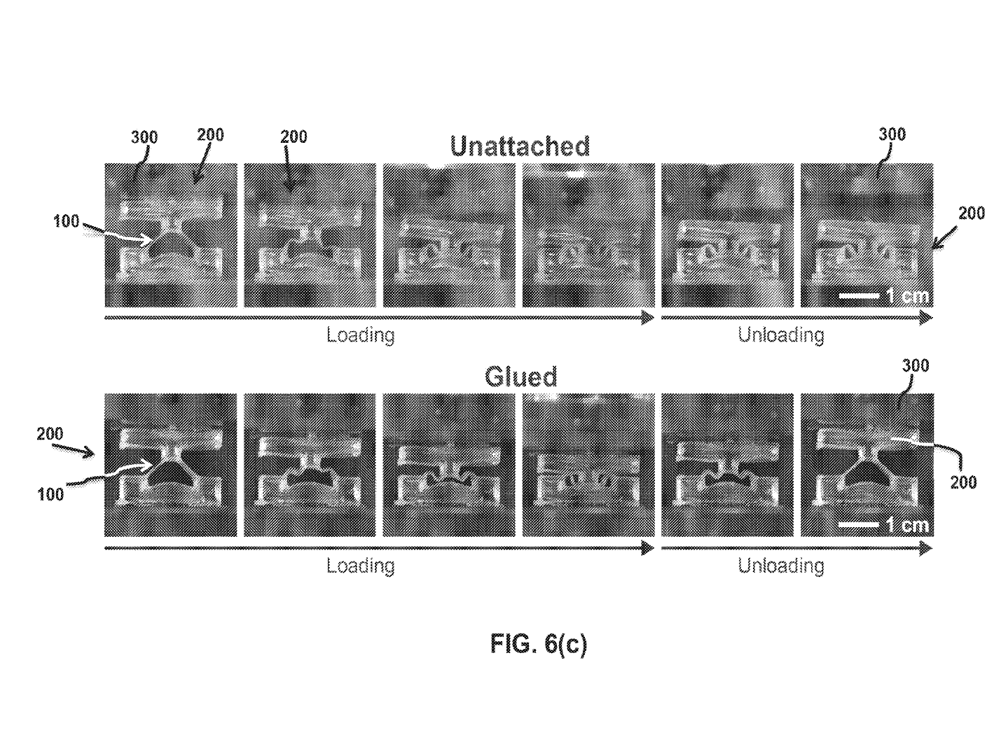

Recent advances in additive manufacturing (i.e., 3D printing) have created new opportunities to control subtle structural features for the design and fabrication of structural elements, inclusive of non-traditional materials, such as mechanical metamaterials (i.e., structures with mechanical properties defined by their structure rather than their composition, inclusive of cellular solids). In accord with the concepts disclosed herein, additive manufacturing was used to quickly and systematically explore the mechanical response of a variety of configurations of intermediate elements (e.g., tilted beams) and to manufacture energy absorption structures (e.g., both unit cells and larger structures comprising a plurality of unit cells) therefrom. As employed, the additive manufacturing technique was an extrusion-based, 3D printing technique using viscoelastic inks exhibiting a shear-thinning response, which facilitated extrusion through fine deposition nozzles, and a shear elastic modulus that ensured that the printed structure was self-supporting. A broad materials palette was developed for this technique, ranging from polymers to ceramics and metals. In the illustrated examples, a viscoelastic polydimethylsiloxane (PDMS)-based ink was used for direct writing of functional 3D energy absorption structures 10 (see, e.g., FIG. 4(a) and FIG. 6(c)). The ink rheology was designed to ensure both reliable printing behavior and structural integrity prior to subsequently cross-linking the printed material at 100° C. for 30 min. The resulting printed architectures comprised an elastomeric material with an initial shear modulus μ₀=0.32 MPa.

To systematically investigate the effects of structural geometry on mechanical behavior, experiments and simulations were conducted in combination to determine the effect of varying the variables of tilting angle θ and slenderness t/L (with t and L denoting the thickness and length of the beam, respectively) on the ability of the intermediate member (e.g., beam) of a plurality of test unit cells 200 to absorb energy (see generally FIGS. 4(a)-4(f). The unit cells 200 comprising a minimal structure of comprising two identical tilted beams 100, arranged symmetrically to prevent asymmetric deformation were designed and manufactured and connected by two stiff horizontal layers (in-filled epoxy) to constrain lateral motion at their ends, as shown in FIG. 4(a). Within a given batch of formed unit cells 200, the unit cells were constructed with different geometrical parameters, as is shown by way of example in FIG. 4(a), which ranged from θ-1.5-70 and t/L˜0.10-0.33 with L˜1-6 mm. Again, it is to be noted that the scale of the unit cells 200 and features were limited by the particular equipment utilized and, for example, smaller unit cells could be fabricated using a smaller nozzle and larger unit cells could be fabricated using a larger nozzle.

Concurrently, using Finite Element (FE) simulations, two-dimensional numerical models of tilted beams 100 characterized by different combinations of θ and t/L were developed, using the commercial finite element package ABAQUS/Explicit (version 6.12), to simulate the response under uniaxial compression. Assuming plane strain conditions, 2D FE models were constructed using ABAQUS element type CPE6MH and accuracy of each mesh was ascertained through a mesh refinement study. Each tilted beam was deformed by applying a vertical displacement to one of the ends, while completely constraining the motion of the other end. Each tilted beam 100 was deformed by applying a vertical displacement to the top end, while constraining the motion of both ends in the horizontal direction (see FIG. 4(b)). Quasi-static conditions were ensured by monitoring the kinetic energy and introducing a small damping factor. The response of the material was captured using an almost incompressible Neo-Hookean model with initial shear modulus μ₀=0.32 MPa and K₀/μ₁=2500. In each simulation, the evolution of the reaction force in the vertical direction was monitored and the force-displacement data was used to calculate both the energy absorbed by the beam (Eᵢₙ) and the energy cost for the beam to snap back to its undeformed configuration (Eₒᵤₜ) (See also FIGS. 4(d)-4(e)).

The combined experimental and numerical results are reported in FIG. 4(c) and FIGS. 4(d)-4(e) and show an excellent quantitative agreement between experiments (plots 440-460) and simulations (plots 410-430), indicating that additive manufacturing techniques and numerical simulations can be effectively combined to quickly design optimal energy-absorbing structures. FIG. 4(c) shows numerical and experimental force-displacement curves for three beams characterized by (θ, t/L) equal to (25°, 0.15), corresponding to plot 430 (simulation) and plot 460 (experimental), (40°, 0.12), corresponding to plot 420 (simulation) and plot 450 (experimental)) and (60°, 0.14), corresponding to plot 410 (simulation) and plot 440 (experimental) respectively. The force was normalized by μ₀Ld cos θ, where the variable “d” denotes the out-of-plane thickness of the samples), while the displacement was normalized by L sin θ. The force-displacement curves shown in FIG. 4(c) clearly indicate that the response of the system can be tuned by controlling t/L and θ. For example, for a geometry of (θ,t/L)=(25°, 0.15), corresponding to plot 430 (simulation) and plot 460 (experimental), the beams snap during compression, but return to the initial undeformed configuration after the load is removed (i.e., only the initial configuration is stable). However, for (θ, t/L) equal to (40°, 0.12) and (60°, 0.14), there is a brief period of tensile reaction force (see region with negative force in the simulation results in FIG. 4(c)), so the system is bistable and can lock in most of the energy stored during loading. It is noted that the experimental curves 450, 440, respectively, in FIG. 4(c) for θ=40° and 60° show a zero, rather than negative, force in this region due to a brief loss of contact between the unit cells 200 and the compression plate 300 (see, e.g., FIG. 6(c)) when the instability occurred during tests in which the unit cells were not adhered to the compression plates.

To further explore the effect of t/L and θ, a combined numerical and experimental parametric study was performed. The numerical results, summarized in FIGS. 4(d)-4(e), indicate that by increasing θ, while keeping t/L constant, the response of the beams 100 undergoes several transitions. At first, for low values of θ (i.e., nearly horizontal beam orientation, perpendicular to the loading direction), the system exhibits no instabilities (region labeled as “no snap-through” at top of FIGS. 4(d)-4(e)). Then, above a critical value of θ, a snap-though instability is triggered (region labeled as “snap-through without energy lock-in” at top half of FIGS. 4(d)-4(e)), but without bistability. If θ is further increased, the beam becomes bistable, to a degree generally represented by the letter associated with the subregions indicated in the middle portions of FIGS. 4(d)-4(e). Finally, above a critical threshold, the snap-through instability is suppressed (region labeled “no snap-through (self-contact) in bottom half of FIGS. 4(d)-4(e)). It was also observed that, within the bistable domain, the energy that the system absorbs (Eᵢₙ) increases as a function of both θ and t/L, but the energy cost for a beam 100 to snap back to its undeformed state (Eₒᵤₜ) tends to decrease.

As a result, it is likely that for large values of θ and t/L (within the bistable region), the system cannot maintain the second stable configuration due to small geometric imperfections or even a time dependency (e.g., viscoelasticity) of the material itself. For this reason, it is important to choose the system parameters such that one can maximize Eᵢₙ while maintaining Eₒᵤₜ above a threshold that depends on the environment for which the system is designed. In addition to the numerical study, an experimental parametric study was performed by fabricating minimal structures (i.e., unit cells 200) over the same combinations of θ and t/L. Of particular interest was the transition between geometries that result in bistability and those that merely possess the snap-through instability but are not bistable. The black dashed lines in FIGS. 4(d)-4(e) indicate the approximate location of this transition as measured experimentally, which is in very close agreement with the numerical results. Discrepancies are dictated by the fact that structural defects become more important here since Eₒᵤₜ is very low.

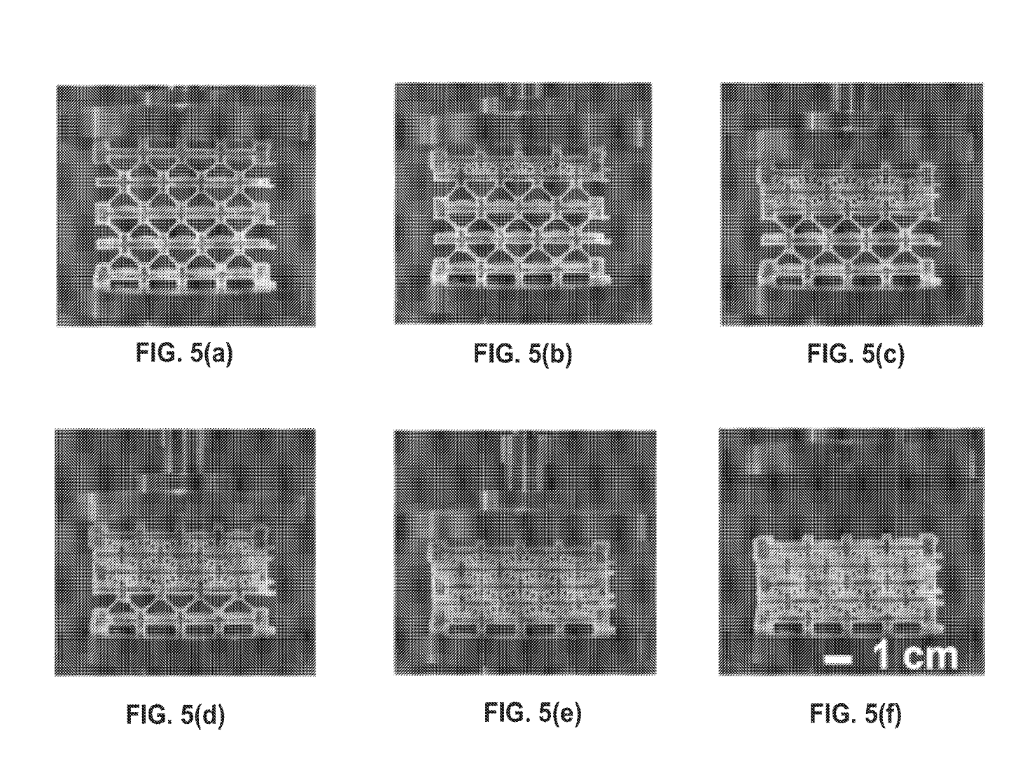

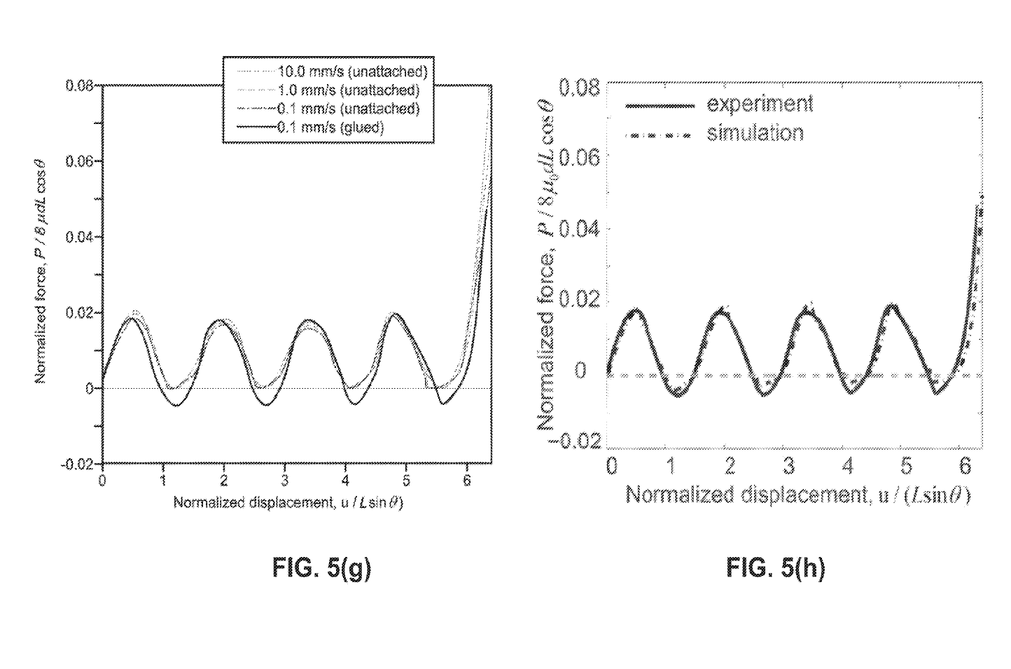

To build practical energy-absorbing structures 10, exemplary systems comprising 4×4 arrays of the unit cells 200 comprising symmetric intermediate members 100 were formed to provide a total of 32 tilted intermediate members (e.g., beams in the test structure). As shown in FIGS. 5(a)-5(f), if t/L and θ are chosen such that each beam is bistable (in this case, θ=40° and t/L=0.12, with L=5 mm), the structure is characterized by multiple stable configurations that can be triggered by applying a compressive force and that are maintained also when the force is removed. As noted above, a relatively small tensile force (or energy), as compared to the force (energy) required to trigger the snap-through, can be applied to cause the energy-absorbing structure 10 to recover its initial shape.

The response of the energy-absorbing structure 10 under uniaxial compression was characterized using a single-axis materials test system (Instron) with a 10 N load cell. As shown in FIG. 5(b), the force-displacement response is characterized by four similar peaks, each corresponding to the collapse of a row of intermediate members 100. Since each row of intermediate members 100 is designed with the same geometrical parameters in the tested configurations, each of these peaks is seen to occur at nearly identical forces (with small imperfections or the environment leading to sequential, rather than simultaneous, collapse of the rows). Remarkably, the magnitude of these peaks for the 4×4 structures is in excellent agreement with that observed from the tests of the unit cells 200, highlighting the modularity and scalability of the structural motif.

The test data also indicates that, despite compression of the energy-absorbing structure 10 at different speeds between 10 mm/s and 0.1 mm/s, the force-displacement curves were found to be rate-independent in the tested regime, as expected, with the structure absorbing the same amount of energy per unit mass (0.91 mJ/g) when fully compressed. Each of the four layers of the energy-absorbing structure 10 of FIGS. 5(a)-5(h) comprises eight tilted beams, in parallel, with each of these layers arranged in series. Given this modularity, the total structural response can be predicted using the FE result for the corresponding single beam.

The subsequent comparison between numerical and experimental results (FIG. 5(h)) is excellent, demonstrating that the knowledge of the response of the unit cell 200 is enough to design larger and more complex structures with tailored properties. This could be extended, e.g., by designing the different rows with different geometrical parameters in order to engineer a structure with a graded mechanical response. For example, an energy-absorbing structure 10 may comprise a first layer or row of intermediate members 100 could have a first θ and t/L, a second layer or row of intermediate members 100 could have a second θ and t/L different than that of the first layer or row, and a third layer or row of intermediate members 100 could have a third θ and t/L different than that of the first or second layers or rows. Likewise, an energy-absorbing structure 10 may comprise a first plurality of layers or rows of intermediate members 100 having a first θ and t/L, a second plurality of layers or rows of intermediate members 100 having a second θ and t/L different than that of the first plurality of layers or rows, and a third plurality of layers or rows of intermediate members 100 having a third θ and t/L different than that of the first or second plurality of layers or rows. Moreover, although the results reported in FIGS. 5(a)-5(h) are for a structure characterized by L=5 mm, the same strategy can be applied to structures with various length scales, as is represented by the different scales shown in FIGS. 6(a)-6(b), since the exploited mechanical instability is scale-independent where the continuum assumption holds.

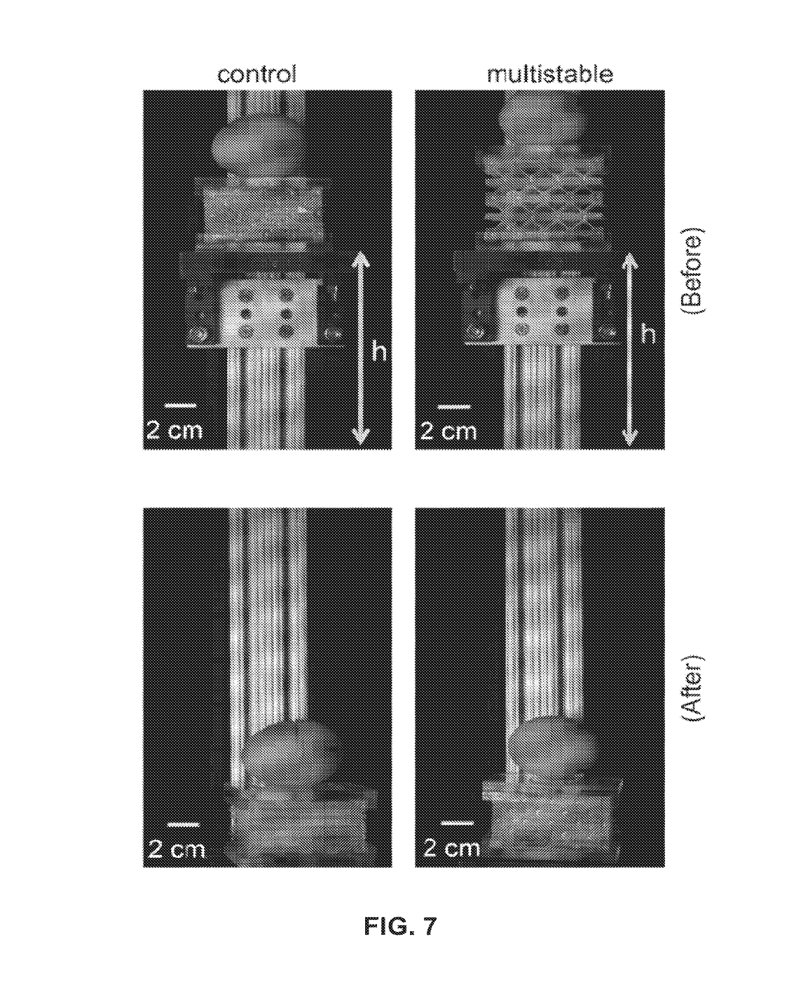

The ability of the system to provide protection during impact was characterized by dropping the energy absorption structures 10 from different heights, h, while recording the resulting acceleration with a piezoelectric accelerometer (PCB Piezotronics, Inc., model number: 352C23) attached to their top. To illustrate this suitability of the disclosed energy absorbing structures 10 to protect an object from impact, and by extension protecting a person from impact, raw eggs were attached to top surfaces of a multistable structure (right images, FIG. 7) and a control sample (left images, FIG. 7) and these structures, bearing the raw eggs, were dropped from a variety of heights (h) (e.g., 5 cm, 7.5 cm and 10 cm), with each test being performed 10 times. The control structure consisted of the same structure as that of the multistable energy absorbing structure 10, but the intermediate members 100 were collapsed and taped in the collapsed state prior to the drop test. To limit out-of-plane motion, three identical structures 10 were connected in parallel by an acrylic fixture. Moreover, to ensure accuracy and consistency across the measurements, a set-up comprising a slide rail and a stage, seen in the background of FIG. 7, was used to guide the fall of the sample.

As shown in FIG. 7, the raw eggs attached to the multistable energy-absorbing structure 10 did not break, while the eggs on the control samples broke upon impact. Of particular interest is the fact that, after the impact, the multistable energy-absorbing structure 10 can be reused, maintaining the same energy absorption characteristics regardless of loading history. In fact, its initial state can be easily recovered by applying a tensile force.

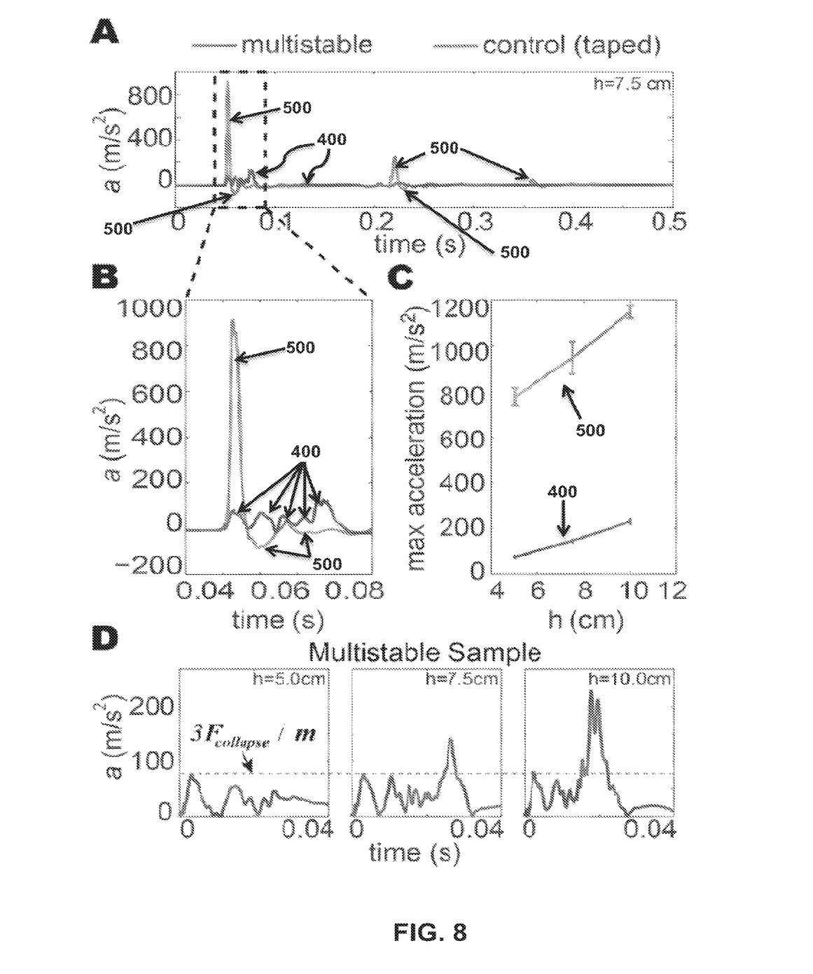

The results of the drop testing is shown in FIG. 8(a)-8(d), which shows comparisons of the data for an undeformed multistable structure 10 (i.e., which subsequently “snaps” to new stable collapsed configurations during impact) and control sample. It is seen, initially, that the plot 400 of the peak acceleration for the multistable structure (i.e., allowed to snap a new configuration during the drop test) is significantly reduced and the bouncing of the sample after impact was suppressed (FIG. 8, graphs A and B, reference numeral 400). Moreover, it can be observed that the acceleration-time curve 400 for the multistable structure is characterized by 4 peaks at about 80 m/s², each corresponding to the collapse of a layer or row of intermediate members 100. It is noted that this value of acceleration corresponds to a force F=m×a=0.125 kg×80 m/s²=10 N, which is in excellent agreement with the collapse-force measured during the quasi-static compression of the energy absorption structures 10. This remarkable result further highlights the rate-independence of the mechanics of the system, as the collapse-force during impact would not typically be expected to be the same as during quasistatic compression.

As the drop height h is increased (FIG. 8, graph D) from 5.0 cm to 10.0 cm, eventually the kinetic energy of the structure immediately prior to impact exceeds the cumulative dissipative potential of the snapping beams in all four rows. As a result, for high enough h (7.5 cm and above in this case) an additional acceleration peak for the multistable structure 10 emerges (see FIG. 8, graph D), corresponding to loading of the densified structure after all four rows of beams have fully collapsed. The design of an energy absorbing structure 10 for a given application can be optimized by maximizing the energy dissipated during collapse of the beams and/or by adding additional layers of beams or other configurations of intermediate elements 100, subject to the constraint that the acceleration remains below a particular acceleration that would be damaging for that application. By way of illustration, the tested multistable structure 10 could we formed with yet another row (i.e., a fifth row) of intermediate elements 100 to attenuate the acceleration peak for the instance where h is equal to 10.0 cm. The energy dispersion for such structure and application can thus be controlled by structural parameters such as, but not limited to, θ, t/L, and the out-of-plane thickness of the structure.

Further comparison between the multistable and control samples clearly shows the ability of the bistable beams to improve impact performance, yielding up to one order of magnitude reduction in peak acceleration amplitude when h was varied between 5 and 10 cm (FIG. 8, graph C). The error bars in FIG. 8, graph “C” indicate standard deviations from multiple measurements. Samples with beam geometries designed to possess the snap-through instability, but not to be bistable (θ=20° and t/L=0.11), were tested and were found to absorb significantly less energy. In this case, the simulations predicted no energy absorption, as material dissipation was not accounted for, while in the experiments there is some energy absorption due to viscoelasticity. However, the energy dissipated highly depends on the material properties and is not of the same magnitude as the structural absorption due to beam snapping in the multistable structure.

In view of the above, the combined numerical calculations and customized additive manufacturing technique demonstrate that the structures and methods disclosed herein to harness snap-though instabilities in tilted elastic beams permit the design of reusable energy-absorbing structures. The present concepts offer a unique range of advantages, as they can be applied to structures with various length scales (from micro to macro) and they provide a simple modular design scheme permitting a structure's mechanical response to be readily tuned by controlling geometric parameters. Moreover, the loading process is fully reversible, allowing the structures in accord with the present concepts to be consistently reused many times, with the energy absorption being unaffected by the loading rate and/or loading history.

The present concepts provide not only tunable and reusable energy absorbing materials, but an entirely new class of structures that can be utilized for a wide range of applications, including reusable bumpers, protective cases for sensitive equipment, and position controllers in soft robotics. Furthermore, since the findings disclosed herein are independent of material properties, the concepts and structural designs may be utilized in conjunction with different classes of materials, for example, to produce stimuli-responsive structures capable of recovering when exposed to an environmental cue (e.g., recovery of a structure based on toluene-induced polymer swelling, which could provide a triggering method for state switching in engineering applications), or to obtain enhanced total energy dissipation by introducing material-dependent dissipative mechanisms, at other length scales.

As to fabrication, the structures described above were manufactured using direct ink writing, a facile extrusion-based 3D printing method. A viscoelastic polydimethylsiloxane (PDMS) ink was extruded through a tapered nozzle (with various nozzles used depending on the desired structure size—200 μm inner diameter tapered nozzle from Nordson EFD and 102 μm and 51 μm tapered nozzles from GPD Global). Ink extrusion was pressure controlled via Nordson EFD Ultimus V pressure box, with the nozzle precisely positioned using a custom 3D positioning stage (Aerotech).

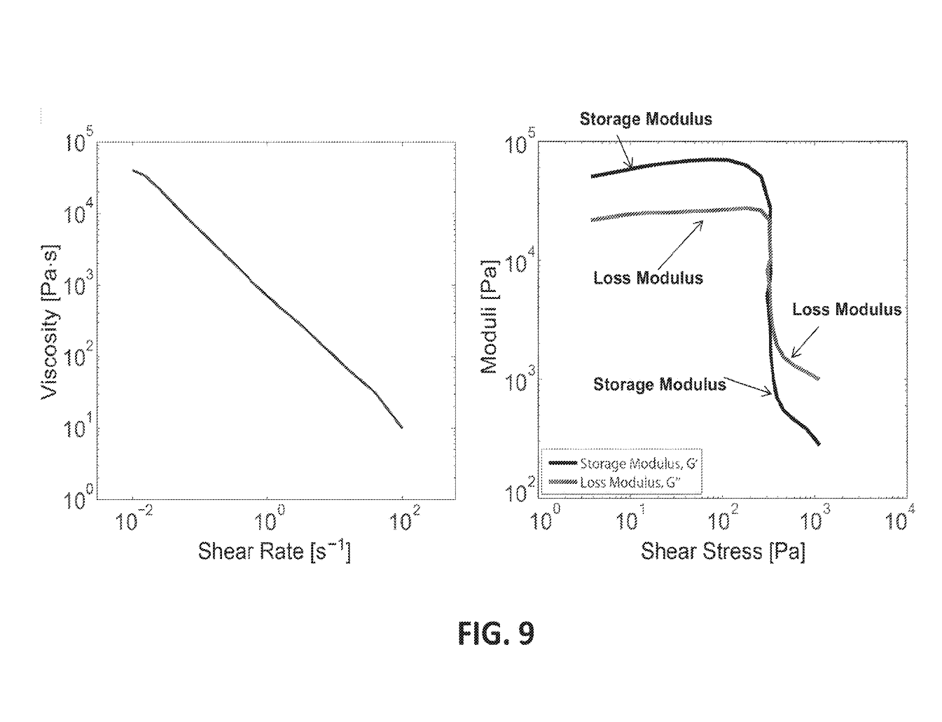

The PDMS-based ink is created by mixing Dow Corning SE-1700 (85 wt. %) with Dow Corning Sylgard 184 (15 wt. %). The viscoelastic yield properties were tailored to ensure that the uncured ink both flowed readily during printing, yet maintained its shape until it is permanently cross-linked in a subsequent curing step (e.g., 100° C. for 30 min). It is to be noted that this act of cross-linking is generally material and configuration dependent and expressly includes cross-linking by application of any energy, whether by heat, pressure, change in pH, and/or radiation (e.g., gamma-radiation, UV light, etc.). For the present example, after curing, the horizontal supporting members of the structure were infilled with epoxy (Momentive Epon 828) to prevent structural bending that would disrupt the precise geometries of the elastomeric beams. As a result, the mechanical deformation of the printed structures was determined solely by the elastomeric beams. The shear-thinning and viscoelastic yield behavior of the PDMS ink are shown in FIG. 9. Rheology measurements were made using a TA Instruments AR 2000EX rheometer with both 40 mm diameter plates (both flat as well as 2° cone).

The cured PDMS ink was tested under uniaxial tension using a single-axis Instron. The tests showed that the material exhibited a behavior typical for elastomers: large strain elastic behavior with negligible rate dependence and negligible hysteresis during a loading-unloading cycle. The structures were compressed using flat compression fixtures and, to test whether the response was rate-dependent, the structures were compressed at three different speeds—10 mm/s, 1 mm/s and 0.1 mm/s (in addition to higher rate impact tests). The compression testing of the multistable structure shown in FIGS. 5(a)-5(f) in the main text (the normalized data are reported in FIG. 3B in the main text) showed that the measured force required to collapse a line of beams (F_{collapse}˜3.1N) agrees strongly with the acceleration peaks observed during the drop tests (a˜80 m/s²). In fact, this value of acceleration corresponds to a force F=m×a=0.125 kg×80 m/s²=10 N (m=0.125 kg being the mass of the egg), that is approximately 3F_{collapse}, with the factor of three introduced because three identical samples arranged in parallel were used for the drop tests.

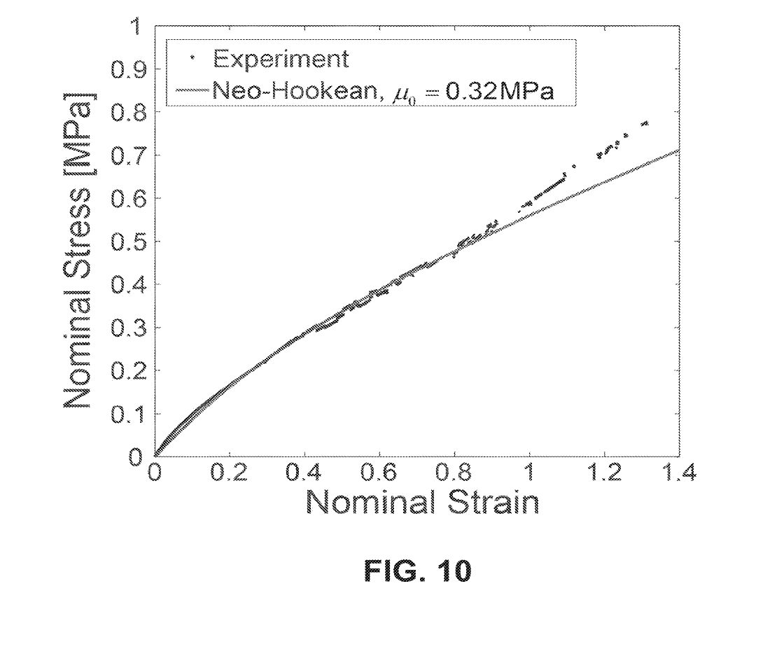

The material behavior at a strain rate of 0.0087 s⁻¹ is reported in FIG. 10. The observed constitutive behavior is modeled as hyperelastic. Let

$$F = \frac{\partial x}{\partial X}$$

be the deformation gradient, mapping a material point from the reference position X to its current location x and J be its determinant, J=detF. For an isotropic hyperelastic material the strain energy density W can be expressed as a function of the invariants of the right Cauchy-Green tensor C=F^{T}F (or, alternatively, also the left Cauchy-Green tensor B=FF^{T}). In particular, the behavior of nearly incompressible materials is effectively described by splitting the deformation locally into volume-changing (J^{1/3}I) and distortional (F̅) components as

F=(J^{1/3}I)F̅ (Eq. 1)
where I denotes the identity matrix.

The PDMS stress-strain behavior is modeled using a Neo-Hookean model, modified to include compressibility (with a high bulk modulus):

$$W = \frac{{μ}_{0}}{2} ( {\overline{I}}_{1} - 3 ) + \frac{{K}_{0}}{2} {( J - 1 )}^{2} , \qquad ( Eq . 2 )$$

where μ₀ and K₀ are the initial shear and bulk moduli and Ī₁=tr(F̅^{T}F̅).

The nominal (first Piola-Kirchoff) stress is then given by

$$S = \frac{\partial W}{\partial F} = [ {μ}_{0} dev \overline{B} + {K}_{0} J ( J - 1 ) ] {F}^{- T} , \qquad ( Eq . 3 )$$

where B̅=F̅F̅^{T} and dev is the deviatoric operator.

The material was modeled as nearly incompressible, characterized by K₀/μ₀≈2500. From the uniaxial tension data, the initial shear modulus was measured to be μ₀=0.32 MPa. It was determined that the above-noted Neo-Hookean model accurately captured the behavior up to a strain of about 1.0, which covers the majority of the strain levels studied.

To manufacture larger structures (i.e., for L at the centimeter scale or larger) a molding approach may be advantageously employed, as noted above. By way of example, a negative mold is fabricated using a conventional mold-forming process. In one aspect, the negative mold is formed using a 3D printer (Connex 500, manufactured by Objet, Ltd.) with VeroBlue (product number: RGD840, Objet) material. The structures 10 were then cast using a silicone rubber (Mold Max 10 from Smooth-On, Inc.). Before replication, a releasing agent (Easy Release 200 available from Smooth-On, Inc.) was sprayed on to the molds to facilitate easy separation. The casted mixture was placed in vacuum for degassing and was allowed to set at room temperature for curing. In the resulting structures 10, each beam or intermediate member 100 of the structures 10 had a length L=6 mm, thickness t=1 mm and out-of-plane height d=30 mm to minimize out-of-plane buckling. The overall size of the structure 10 was W (width)×H (height)×D (thickness)=10.6 cm×10.8 cm×3.0 cm. As shown in FIG. 1(a), the structure 10 is characterized by multiple stable configurations that can be triggered by applying a compressive force and that are maintained also when the force is removed.

The FE simulations of individual elastic tilted beams were used to predict the response of the multistable structures 10. In fact, the structure shown in FIGS. 5(a)-5(f) consists of four rows of eight parallel tilted beams, with each of these rows arranged in series. Moreover, the horizontal layers (infilled with epoxy) are much stiffer than the beams, so that they behave as rigid bodies and only the beams deform. To predict the response of a multistable structure 10, the numerically obtained force-displacement curve of the corresponding individual beam were fitted to that of a polynomial. In particular, for the structure shown in FIGS. 5(a)-5(f), the FE results obtained for a single beam with θ=40° and t/L=0.12 were used to fit the force-displacement curve with a polynomial of degree 10:

P(u)=0.0005u¹⁰−0.0133u⁹+0.1395u⁸−0.8079u⁷+2.8184u⁶−5.9982u⁵+7.3955u⁴−4.2852u³−0.2205u²+1.2877u (Eq. 4)

The polynomial of Eq. 4 was obtained for a beam with L=5.06 mm, out-of-plane thickness d=14.8 mm and shear modulus μ₀=0.32 MPa.

Therefore, each beam 100 in the multistable structure 10 can be treated as a non-linear spring, whose force-displacement behavior is given by Eq. 4. Moreover, each layer of beams or intermediate elements 100 comprises, in the present example, eight of such non-linear springs in parallel, so that

P_{row-i}(u_{row-i})=8P(u_{row-i}), i=1,2,3,4 (Eq. 5)
where P_{row-i} and u_{row-i} are the total force and the displacement of the i-th row of beams.

Furthermore, each structure consists of four such layers arranged in series, so that equilibrium and compatibility require that

$$u = {\sum }_{i = 1}^{4} {u}_{row - i} \qquad ( Eq . 6 )$$

P_{row-1}(u_{row-1})=P_{row-2}(u_{row-2}) (Eq. 7)

P_{row-2}(u_{row-2})=P_{row-3}(u_{row-3}) (Eq. 8)

P_{row-3}(u_{row-3})=P_{row-4}(u_{row-4}) (Eq. 9)

The system of non-linear equations (S6) is solved numerically for increasing values of the applied displacement u using the trust-region-dogleg algorithm implemented in Matlab. Finally, to capture the sequential, rather than simultaneous, collapse of the rows observed in the experiments (due to imperfections), small perturbations were introduced into Eq. 6. More specifically the terms P_{row-i}(u_{row-i}) were multiplied by a coefficient close to 1.0 (i.e. αᵢP_{row-i}(u_{row-i}) with α₁=0.94, α₂=0.99, α₃=1.02 and α₄=1.04).

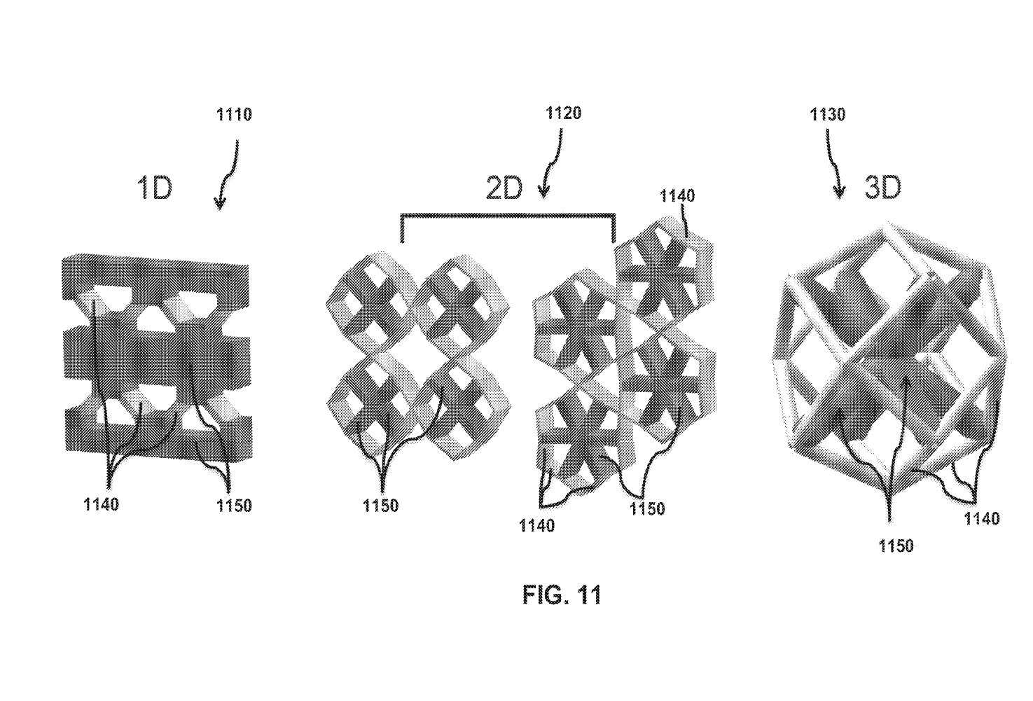

FIG. 11 shows schematic views of 1D energy-trapping meta-materials 1110, 2D energy-trapping meta-materials 1120 and 3D energy-trapping meta-materials 1130 in accord with at least some aspects of the present concepts comprising bistable intermediate members, such as beam-like members, 1140 (lighter-colored members) and rigid support structures 1150 (darker-colored members) arranged, in combination, to absorb energy as is discussed above.

In accord with the concepts disclosed herein, a novel design of elastic cellular structures for energy absorption is characterized by a combined set of features from formerly exclusive classes of materials, simultaneously yielding a structure that is reusable, recoverable, dissipative and with limited peak stress. The present concepts demonstrate that snap-though instabilities in tilted elastic members can be harnessed to design reusable energy-absorbing structures. This strategy offers a design scheme which is simultaneously scale-independent and modular with structures possessing a loading process that is fully reversible and rate independent. Since the mechanism is not particular to a specific or exotic material, common inexpensive materials can be used. The findings presented herein thus open new opportunities for designing energy absorbing materials and provide a new class of structures that can be utilized for a wide range of applications, including reusable vehicle bumpers (or non-vehicle bumpers), protective cases for sensitive equipment, and position controllers in soft robotics. The present concepts are also particularly suited to roadside barriers (e.g., vehicle crash barriers, guard rails, median barrier, work zone barrier, etc.) or equipment are designed to maximize performance and minimize cost. Thus, the present concepts be utilized as a vehicle-born platform to provide energy dissipation in vehicle-to-vehicle accidents or vehicle-to-pedestrian accidents, or may advantageously be used statically in roadside barriers to reduce the potential for serious occupant injuries owing to more favorable decelerations during a crash/accident, should a vehicle contact such roadside barrier. Yet further, the reusable and reversible energy absorption structures 10 disclosed herein would reduce the cost associated with traffic accidents.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. An energy absorbing cell, comprising:
a first structural element,
a second structural element disposed at least substantially parallel to the first structural element and spaced apart from the first structural element by a gap;
a first intermediate member disposed at a first angle between the first structural element and the second structural element, the first intermediate member being attached at a first end to a first portion of the first structural element and being attached at a second end to a first portion of the second structural element; and
a second intermediate member disposed at a second angle between the first structural element and the second structural element, the second intermediate member being attached at a first end to a second portion of the first structural element and being attached at a second end to a second portion of the second structural element;
wherein at least the first intermediate member and the second intermediate member are formed from an elastic material,
wherein the first angle and the second angle, and a thickness to length ratio of the first intermediate member and the second intermediate member, are selected so that application of a compressive force to displace the first structural element and the second structural element toward one another triggers a snap-through instability in both the first intermediate member and the second intermediate member.

2. The energy absorbing cell of claim 1, wherein the thickness to length ratio is between about 0.09 and 0.21.

3. The energy absorbing cell of claim 2, wherein the first angle and the second angle are between about 5° and 75°.

4. The energy absorbing cell of claim 1, wherein the thickness to length ratio is between about 0.09 and 0.14, and wherein the first angle and the second angle are between about 15° and 75°.

5. The energy absorbing cell of claim 1, wherein the thickness to length ratio is between about 0.13 and 0.15, and wherein the first angle and the second angle are between about 25° and 70°.

6. The energy absorbing cell of claim 1, wherein the thickness to length ratio is between about 0.15 and 0.17, and wherein the first angle and the second angle are between about 25° and 65°.

7. The energy absorbing cell of claim 1, wherein the thickness to length ratio is between about 0.16 and 0.19, and wherein the first angle and the second angle are between about 35° and 60°.

8. The energy absorbing cell of claim 1, wherein the thickness to length ratio is between about 0.18 and 0.21, and wherein the first angle and the second angle are between about 35° and 55°.

9. The energy absorbing cell of claim 1, wherein the first angle, second angle, first intermediate member thickness to length ratio, and second intermediate member thickness to length ratio are selected to ensure that the energy absorbed by the first intermediate member and the second intermediate member is greater than the energy required to return the first intermediate member and the second intermediate member to their initial state.

10. The energy absorbing cell of claim 1, wherein the first structural element, second structural element, first intermediate member and second intermediate member are formed as a unitary structure.

11. The energy absorbing cell of claim 1, wherein the first structural element and the second structural element comprise structural features dimensioned to spatially complement one another in conjunction with the snap-through instability in the first intermediate member and the second intermediate member.

12. The energy absorbing cell of claim 1, wherein a length of the first intermediate member and second intermediate member are at least substantially equal.

13. An energy absorbing structure, comprising:
a plurality of energy absorbing cells, including at least a first energy absorbing cell and a second energy absorbing cell;
wherein the first energy absorbing cell comprises a first structural element, a second structural element disposed at least substantially parallel to the first structural element and spaced apart from the first structural element by a gap, a first intermediate member disposed at a first angle between the first structural element and the second structural element and being attached at a first end to a first portion of the first structural element and being attached at a second end to a first portion of the second structural element, and a second intermediate member disposed at a second angle, between the first structural element and the second structural element and being attached at a first end to a second portion of the first structural element and being attached at a second end to a second portion of the second structural element, at least the first intermediate member and the second intermediate member being formed from an elastic material, and the first angle and the second angle being selected so that application of a compressive force to displace the first structural element and the second structural element toward one another triggers a snap-through instability in both the first intermediate member and the second intermediate member, and
wherein the second energy absorbing cell comprises a first structural element, a second structural element disposed at least substantially parallel to the first structural element and spaced apart from the first structural element by a gap, a first intermediate member disposed at a first angle between the first structural element and the second structural element and being attached at a first end to a first portion of the first structural element and being attached at a second end to a first portion of the second structural element, and a second intermediate member disposed at a second angle, between the first structural element and the second structural element and being attached at a first end to a second portion of the first structural element and being attached at a second end to a second portion of the second structural element, at least the first intermediate member and the second intermediate member being formed from an elastic material, and the first angle and the second angle being selected so that application of a compressive force to displace the first structural element and the second structural element toward one another triggers a snap-through instability in both the first intermediate member and the second intermediate member.

14. The energy absorbing structure of claim 13, wherein the first angle and the second angle of the first energy absorbing cell, the second energy absorbing cell, or both the first and the second energy absorbing cells are at least substantially equal and are between about 5° and 75°, and wherein the first intermediate member and the second intermediate member of the first energy absorbing cell, the second energy absorbing cell, or both the first and the second energy absorbing cells have a thickness to length ratio between about 0.09 and 0.21.

15. The energy absorbing structure of claim 13, wherein the first angle, second angle, first intermediate member thickness to length ratio, and second intermediate member thickness to length ratio of the first energy absorbing cell, the second energy absorbing cell, or both the first and the second energy absorbing cells are selected to ensure that the energy absorbed by the first intermediate member and the second intermediate member of the respective energy absorbing cell or cells is greater than the energy required to return the first intermediate member and the second intermediate member to their initial state.

16. The energy absorbing structure of claim 13, wherein the first structural element and the second structural element of the first energy absorbing cell, the second energy absorbing cell, or both the first and the second energy absorbing cells are formed from the elastic material used to form the first intermediate member and second intermediate member so as to form a unitary elastic structure.

17. The energy absorbing structure of claim 13, wherein the first structural element and the second structural element of the first energy absorbing cell, the second energy absorbing cell, or both the first and the second energy absorbing cells comprise structural features dimensioned to spatially complement one another in conjunction with the snap-through instability in the first intermediate member and the second intermediate member.

18. The energy absorbing structure of claim 13, wherein the plurality of energy absorbing cells are arranged to form an array comprising a plurality of levels.

19. A method of forming an energy absorbing cell, comprising the acts of:
programming an additive manufacturing system to output, from one or more nozzles, one or more viscoelastic materials to print an energy absorbing cell, and
cross-linking the printed energy absorbing cell by applying energy to the printed energy absorbing cell at a predetermined level for a predetermined time period,
wherein the printed energy absorbing cell comprises a first structural element, a second structural element disposed at least substantially parallel to the first structural element and spaced apart from the first structural element by a gap, a first intermediate member disposed at a first angle between the first structural element and the second structural element and being attached at a first end to a first portion of the first structural element and being attached at a second end to a first portion of the second structural element, and a second intermediate member disposed at a second angle between the first structural element and the second structural element and being attached at a first end to a second portion of the first structural element and being attached at a second end to a second portion of the second structural element, the first angle and the second angle being selected so that application of a compressive force to the formed energy absorbing cell to displace the first structural element and the second structural element toward one another triggers a snap-through instability in both the first intermediate member and the second intermediate member.
